(19) United States
(12) Patent Application Publication
(10) Pub. No.: US 2009/0055293 A1
(43) Pub. Date: Feb. 26, 2009

(54) SYSTEM FOR MANAGING INVENTORIES COMPRISING DOWNHOLE TOOLS USED IN THE DRILLING, COMPLETION, AND PRODUCTION OF OIL AND GAS WELLS

(76) Inventor: Timothy J. Mueller, Plano, TX (US)

Correspondence Address: Michael A. O'Neil;Michael A. O'Neil, P.C., Suite 820, 5949 Sherry Lane, Dallas, TX, 75225, US

(21) Appl. No.: 11/844,041

(22) Filed: Aug. 23, 2007

(51) Int. Cl. G06Q 10/00

(52) U.S. Cl. 705/28

(57) ABSTRACT

A method of managing an inventory comprising downhole tools includes the steps of securing a passive RFID device to each downhole tool and utilizing an RFID signal generator/reader to read the passive RFID devices secured to the downhole tools as the downhole tools are introduced into a well. The output from the RFID signal generator/reader is utilized to prepare a listing of all of the downhole tools that have been directed into the well including the location of each of the downhole tools relative to each other. The RFID signal generator/reader is also employed to record the removal of the downhole tools from the well.

### TECHNICAL FIELD

This invention relates generally to the management of inventories comprising downhole tools used in oil and gas wells, and more particularly to an RFID system for identifying individual tools.

### BACKGROUND AND SUMMARY OF THE INVENTION

As is well known, companies involved in the drilling, completion, and production phases of oil and gas well installations utilize literally thousands of downhole tools. Heretofore it has been impractical if not impossible for such companies to log individual tools into inventory; track the usage of individual tools in drilling, completion, and production operations; and to ultimately record the removal of individual tools from inventory when the useful life thereof has ended. As a result accidents and failures can occur when a tool that is beyond the end of its service life is inadvertently employed in operations in which the forces applied to the tool are beyond its capabilities.

The present invention comprises a system for effectively managing inventories of downhole tools utilized in the drilling, completion, and production phases of oil and gas wells. In accordance with the broader aspects of the invention every downhole tool obtained by an oil and/or gas well drilling/completion/production company it is provided with a passive RFID tag when it is received in inventory. By providing each tool with an RFID tag utilization of the tool can be tracked throughout its useful life. This in turn assures that the tool is not disposed of prematurely and, conversely, that the tool is not exposed to service conditions that are beyond its expected capability.

In accordance with more specific aspects of the invention an RFID signal generator/reader is provided at each well head. As individual tools are directed into the well the RFID signal generator/reader reads the RFID tag mounted on the tool and records an inventory control number associated therewith. In this manner an inventory of each and every tool currently in use in the well is established and maintained. Subsequently, when the tool is removed from the well the RFID signal generator/reader reads the RFID tag mounted thereon and records the inventory control number associated therewith. In this manner both the removal of the tool from the well and the availability of the tool for subsequent service is established and made known to company management.

In accordance with still more specific aspects of the invention each downhole tool comprising the inventory of an oil and gas well drilling/completion/production company is provided with an aperture for receiving a passive RFID device. Each passive RFID device to be utilized in the identification of particular downhole tools preferably comprises a right circular cylindrical casing having passive RFID circuitry contained therein. The casing is provided with a plurality of tabs which engage the cylindrical surface of the aperture formed in the tool thereby securing the passive RFID device in the aperture of the tool and preventing its disengagement therefrom.

### BRIEF DESCRIPTION OF THE DRAWINGS

A more complete understanding of the present invention may be had by reference to the following Detailed Description when taken in conjunction with the accompanying Drawings, wherein:

FIG. 1 is an illustration of a first downhole tool provided with an RFID device in accordance with the present invention;

FIG. 2 is an illustration of a second downhole tool provided with an RFID device in accordance with the present invention;

FIG. 3 is an illustration of a third downhole tool provided with an RFID device in accordance with the present invention;

FIG. 4 is a perspective view illustrating a first RFID device installation system comprising the present invention;

FIG. 5 is a side view further illustrating the RFID device installation system of FIG. 4;

FIG. 6 is a perspective view illustrating a second RFID device installation system comprising the present invention;

FIG. 7 is a side view further illustrating the RFID device installation system of FIG. 6;

FIG. 8 is an exploded perspective view illustrating the RFID signal generator/reader component of the present invention; and

FIG. 9 is an enlargement of a portion of FIG. 8.

### DETAILED DESCRIPTION

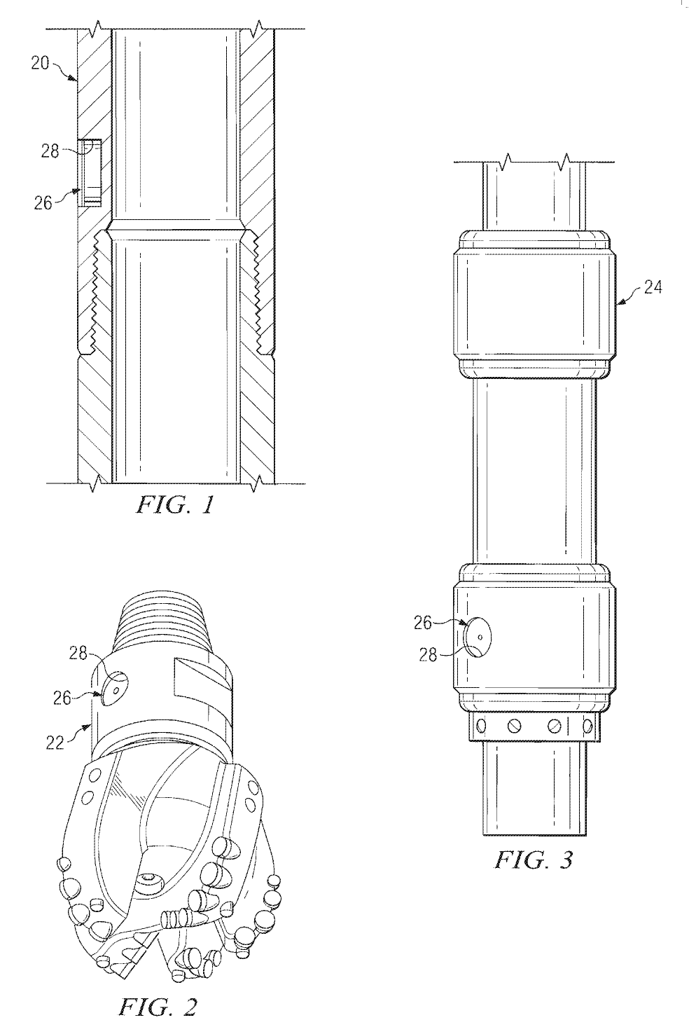

Referring now to the drawings, FIGS. 1, 2, and 3 illustrate downhole oil tools 20, 22, and 24, respectively. As will be appreciated by those skilled in the art, the oil tools 20, 22, and 24 are representative only, it being understood that the present invention is applicable to each and every type and kind of downhole tool utilized in the drilling and/or completion and/or production of an oil or gas well.

Each of the tools 20, 22, and 24 is provided with a passive RFID tag 26. Each passive RFID tag 26 is installed in a cavity 28. As will be understood by those skilled in the art, in accordance with the present invention each and every downhole tool comprising inventory of tools utilized by a particular company in the business of drilling and/or completion and/or production of oil and/or gas wells is provided with a passive RFID device 26 installed in a similar cavity formed in the tool.

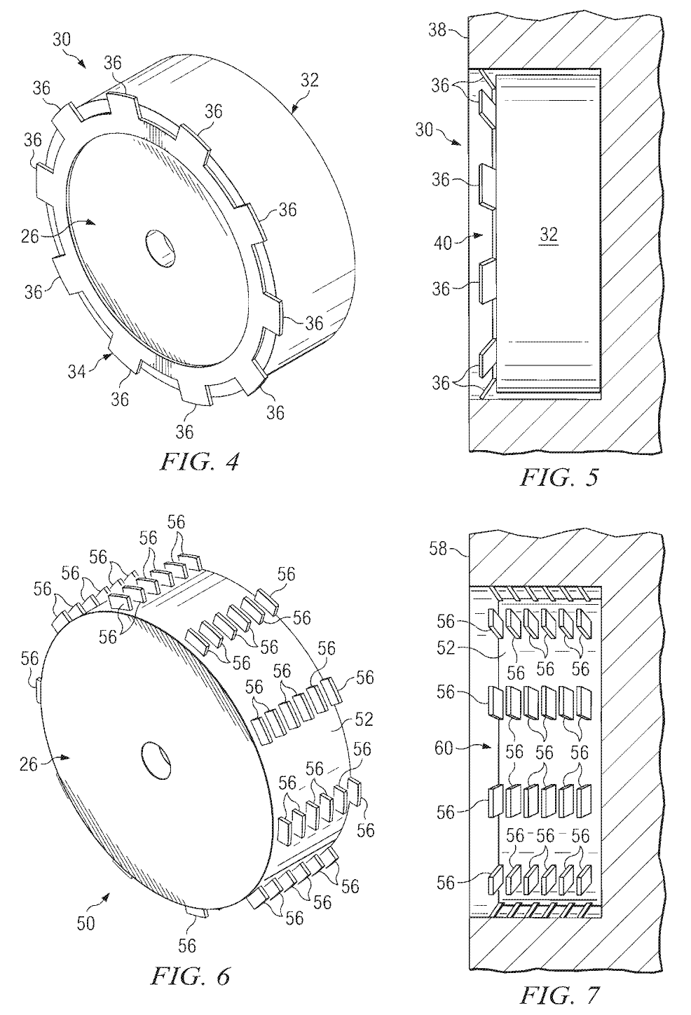

Referring to FIGS. 4 and 5 a first RFID device installation system 30 is shown. In accordance therewith each RFID device 26 is installed in a cylindrical container 32 and is retained therein by a locking ring 34. The locking ring 34 comprises a plurality of radially projecting tabs 36 which initially extend radially outwardly in the plane of the ring 34 as illustrated in FIG. 4.

Referring to FIG. 5 the RFID device 26 is installed in a downhole tool 38 by pushing the cylinder 32 into a cavity 40 formed in the tool 38. As the cylinder 32 is pushed into the cavity 40 the tabs 36 bend outwardly as illustrated in FIG. 5. The distal ends of the tabs 36 engage the side walls of the cavity 40 in a manner resembling a traditional interference fit thereby securely retaining the cylinder 32 and the RFID device 26 installed therein in the cavity 40 formed in the tool 38.

Referring to FIGS. 6 and 7 there is shown an alternative method 50 for retaining an RFID device in a downhole tool. In accordance therewith an RFID device is retained in a cylinder 32 by means of an interference fit between the cylinder 32 and the RFID device 26, means of a suitable adhesive, or by other conventional retaining techniques. The cylinder 32 is provided with a plurality of tabs 56 initially extending radially outwardly from the exterior surface thereof.

A downhole tool 58 has a cavity 60 formed therein. The cylinder 52 and the RFID device 26 mounted therein are installed in the cavity 60 of the tool 58 by pushing the cylinders 52 inwardly into the cavity 60. This action bends the tabs 56 outwardly in the manner illustrated in FIG. 7 thereby securing the cylinder 52 and the RFID device 26 mounted therein in the cavity 60 in the manner of an interference fit. In this manner the RFID device 26 is retained in engagement with the tool 58 throughout the service life of a tool.

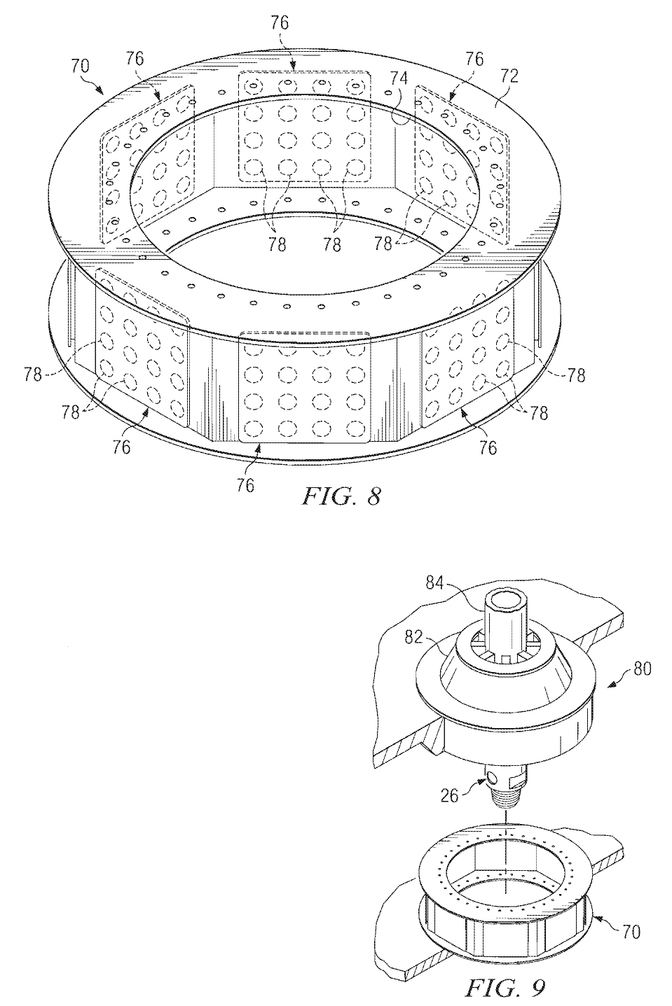

Referring to FIG. 8 the system of the present invention further comprises an RFID signal generator/reader 70. The signal generator/reader 70 comprises a frame 72 having a cylindrical aperture 74 extending therethrough. A plurality of panels 76 are mounted on the frame 72. Each of the panels 76 in turn supports a plurality of RFID signal generator/reader devices 78.

Referring to FIG. 9 the RFID signal generator/reader assembly 70 is mounted at the well head 80 of an oil or gas well. The well head 80 includes a rotary table 82. Although a particular downhole tool 84 is illustrated in FIG. 9 it will be understood that every downhole tool utilized in the drilling and/or completion and/or production of an oil or gas well passes through the well head 80 and through the rotary table 82 when it is installed in the well and again passes through the rotary table 82 and the well head 80 when it is removed from the well.

In accordance with the present invention each downhole tool utilized in a particular well is provided with a passive RFID device 26. As the passive RFID device 26 mounted on a particular tool passes through the RFID signal generator/receiver 70 the components 78 of the system 70 read the passive RFID device 26 of the tool and identify the inventory control number associated therewith. In this manner the operator of the well obtains a listing comprising each and every downhole tool that is utilized in a particular well. The listing also comprises the location of each downhole tool relative to all of the other downhole tools utilized in a particular well.

As is well known to those skilled in the art accurate information regarding the location of a particular downhole tool in a well during utilization thereof can be extremely important. For example, in some instances it is preferable the well extend horizontally through a specific formation such as a the formation known as Barnett Shale. In such cases the lowermost tools in the well must be turned 90°, that is, from a vertical orientation to a horizontal orientation. As is well known to the art, the turning of downhole tools from a vertical orientation to a horizontal orientation imposes considerably more stress on the tools than would be the case if the entire well was vertically oriented.

The foregoing problems are addressed by the present invention by facilitating the preparation and maintenance of a log of every utilization of every downhole tool comprising the downhole inventory of a drilling/completion/production company. This in turn allows the company to determine, for example, when the useful service of the tool has come to an end.

After a particular downhole operation has been completed the downhole tools utilized therein are removed from the well. Once again as the passive RFID device 26 mounted on a particular tool passes through the RFID signal generator/receiver 70 the components 78 of the system 70 read the passive RFID device 26 thereby creating a listing of every downhole tool that has been removed from the well and is now available for further service or, in some cases, removal from service.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A method of managing an inventory comprising a predetermined quantity of downhole tools of the type utilized in the drilling and/or completion and/or production of an oil or gas well including the steps of:
providing a quantity of passive RFID devices at least equal in number to the number of downhole tools comprising the predetermined quantity thereof;
mounting at least one of the passive RFID devices on each of the downhole tools comprising the predetermined quantity thereof;
providing a well;
providing an RFID signal generator/reader;
positioning the RFID signal generator/reader at the entrance to the well;
directing selected downhole tools from the predetermined quantity thereof into the well; and
utilizing the RFID signal generator/reader to read the passive RFID devices secured to the downhole tools from the predetermined quantity thereof that are directed into the well.

2. The method according to claim 1 including the subsequent step of utilizing the RFID signal generator/reader to read the passive RFID devices secured to the downhole tools as they are removed from the well.

3. A method of managing a quantity of downhole tools of the type utilized in the drilling and/or completion and/or production of an oil or gas wells including the steps of:
providing a quantity of downhole tools;
providing a quantity of passive RFID devices at least equal in number to the number of downhole tools comprising the quantity thereof;
mounting at least one of the passive RFID devices on each of the downhole tools comprising the quantity thereof;
sequentially directing the downhole tools having the passive RFID devices mounted thereon into a well;
reading the passive RFID device secured to each of the downhole tools as the downhole tool is directed into the well; and
preparing a log comprising the listing of every downhole tool that has been directed into the well.

4. The method according to claim 3 including the additional step of:
providing an RFID signal generator/reader;
positioning the RFID signal generator/reader at the entrance to the well; and
utilizing the RFID signal generator/reader to read the passive RFID devices secured to the downhole tools as the downhole tools are directed into the well.

5. The method according to claim 4 including the additional step of:
utilizing the RFID signal generator/reader to read the passive RFID devices secured to the downhole tools as the downhole tools are removed from the well.
